(19) United States
(12) Patent Application Publication
(10) Pub. No.: US 2010/0165197 A1
(43) Pub. Date: Jul. 1, 2010

(54) DISPLAY PROCESSING APPARATUS

(76) Inventor: Satoshi Hattori, Kumagaya-shi (JP)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 12/721,403

(22) Filed: Mar. 10, 2010

Related U.S. Application Data
(63) Continuation of application No. PCT/JP2008/070264, filed on Oct. 30, 2008.

(30) Foreign Application Priority Data
Oct. 31, 2007 (JP) 2007-283848

(51) Int. Cl. H04N 3/27

(52) U.S. Cl. 348/554; 348/E03.049

(57) ABSTRACT

According to one embodiment, a display processing apparatus comprises a first input terminal of the HDMI standard, configured to be connectable to an external apparatus, a detector configured to detect (i) a first signal which is included in an input signal supplied from the first input terminal, and (ii) a second signal which is included in the input signal supplied from the first input terminal and which is different from the first signal, and a generator configured to determine whether the external apparatus is not in a standby state but in an operating state based on a detecting result of the detector, and to generate an input signal selection screen representing the operating state of the external apparatus when the external apparatus is determined to be in the operating state.

### CROSS-REFERENCE TO RELATED APPLICATIONS

This is a Continuation Application of PCT Application No. PCT/JP2008/070264, filed Oct. 30, 2008, which was published under PCT Article 21(2) in English.

This application is based upon and claims the benefit of priority from Japanese Patent Application No. 2007-283848, filed Oct. 31, 2007, the entire contents of which are incorporated herein by reference.

### BACKGROUND

1. Field

One embodiment of the present invention relates to a display processing apparatus for displaying signals input to selectable ones of input terminals including terminals of high-definition multimedia interface (HDMI) standard on an input signal selection screen.

2. Description of the Related Art

In recent years, a video signal processing apparatus such as a multimedia television receiver or the like includes very many input terminals, and generally assumes a form in which a signal desired by a user can be arbitrarily selected from these terminals on an input signal selection screen by using a remote controller or the like.

In Jpn. Pat. Appln. KOKAI Publication of such a video signal processing apparatus, in which a user arbitrarily designates unnecessary input terminals that are not used, from many input terminals on an operation screen, whereby the signals of the designated input terminals are not displayed as selection candidates.

However, the prior art technique of Jpn. Pat. Appln. KOKAI Publication No. 2007-36854 entails the troublesomeness that in order to exclude unnecessary selection candidates on the input signal selection screen, the user has to call up an operation screen, and arbitrarily designate input signals to be eliminated. Further, the user also has to determine one by one which of the input signals is to be excluded in consideration of the connection status.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary block diagram showing the configuration of a receiving device serving as a display processing apparatus which is an embodiment of the present invention;

FIG. 2 is an explanatory view showing the pin arrangement of HDMI terminals handled in the display processing apparatus;

FIG. 3 is an explanatory view showing the pin arrangement of Displayport terminals handled in the display processing apparatus;

FIG. 4 is an explanatory view showing an example of an input signal selection screen in the display processing apparatus;

FIG. 5 is an explanatory view showing an example of a setting screen for setting an input signal detection method in the display processing apparatus;

FIG. 6 is an explanatory view showing an example of relationships between connection statuses of an input terminal and input signal detection methods in the display processing apparatus;

FIG. 7 is an explanatory view showing another example of the input signal selection screen in the display processing apparatus;

FIG. 8 shows explanatory views showing other examples of the input signal selection screen in the display processing apparatus;

FIG. 9 shows explanatory views showing other examples of the input signal selection screen in the display processing apparatus;

FIG. 10 is an explanatory view showing another example of the input signal selection screen in the display processing apparatus; and

FIG. 11 is an exemplary block diagram showing the configuration of a receiving device serving as a display processing apparatus which is another embodiment of the present invention.

### DETAILED DESCRIPTION

Various embodiments according to the invention will be described hereinafter with reference to the accompanying drawings. In general, according to one embodiment of the invention, a display processing apparatus comprises a first input terminal of the HDMI standard, configured to be connectable to an external apparatus, a detector configured to detect (i) a first signal which is included in an input signal supplied from the first input terminal, and (ii) a second signal which is included in the input signal supplied from the first input terminal and which is different from the first signal, and a generator configured to determine whether the external apparatus is not in a standby state but in an operating state based on a detecting result of the detector, and to generate an input signal selection screen representing the operating state of the external apparatus when the external apparatus is determined to be in the operating state.

<An Example of a Display Processing Apparatus which is an Embodiment of the Present Invention>

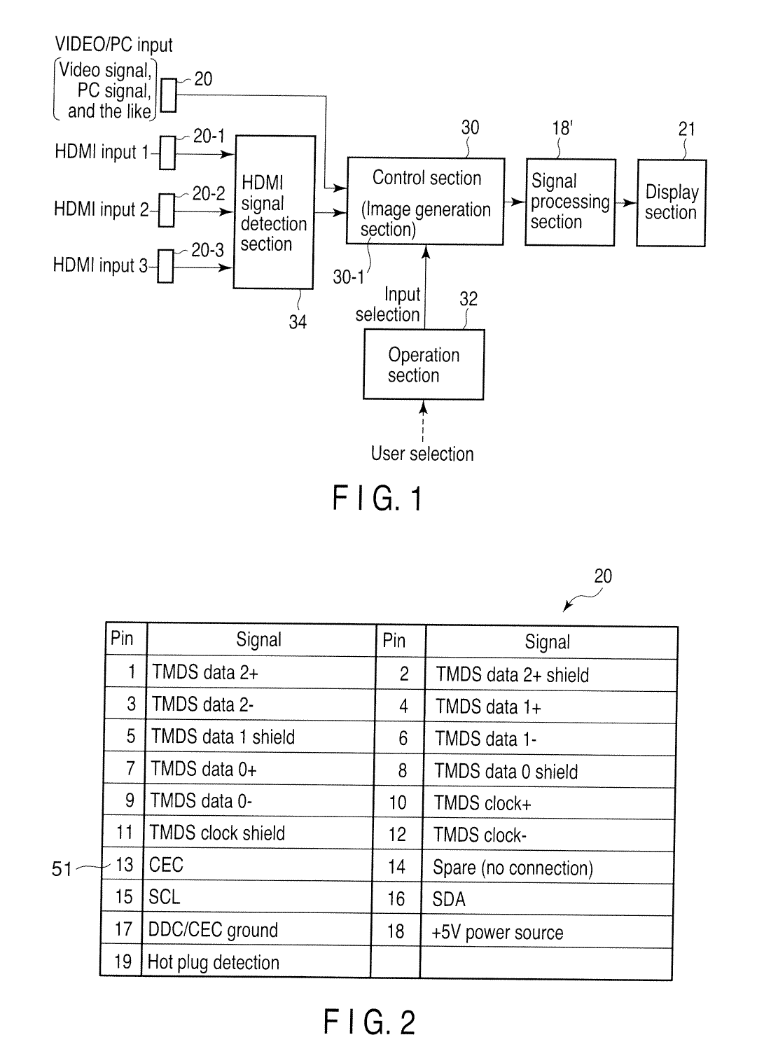

First, the configuration of the display processing apparatus will be described below by using the exemplary drawings. FIG. 1 is an exemplary block diagram showing the configuration of a receiving device serving as the display processing apparatus.

(Configuration)

The receiving device includes a VIDEO/PC input terminal 20, HDMI terminals 20-1, 20-2, and 20-3, an HDMI signal detection section 34, a signal processing section 18′, a control section 30, an image generation section 30-1, a display section 21, and an operation section 32. The VIDEO/PC input terminal 20 is an input terminal for an analog video signal. The HDMI terminals 20-1, 20-2, and 20-3 are input terminals of the HDMI standard which receive input signals each including digital video data and digital audio data.

The HDMI signal detection section 34 detects the signal potential of each of the HDMI terminals 20-1, 20-2, and 20-3. The signal processing section 18′ subjects a video signal to video signal processing, and subjects an audio signal to audio signal processing. The control section 30 controls the overall operations of the apparatus. The image generation section 30-1 generates image signals such as an icon, an input signal selection screen and the like. The display section 21 includes a liquid crystal display panel or the like. The operation section 32 includes a remote controller, operation switches or the like.

(Pin Arrangement of HDMI Terminals and Displayport Terminals)

Further, each of the HDMI terminals 20-1, 20-2, 20-3 has a connector pin arrangement shown in FIG. 2. Here, it is suitable for detecting the connection status of HDMI equipment to make pin-13 Consumer Electronic Control (CEC), pin-15 serial data clock line (SCL), pin-16 serial data analyzer (SDA), and pin-18 +5V power source the detection object of the HDMI signal detection section 34.

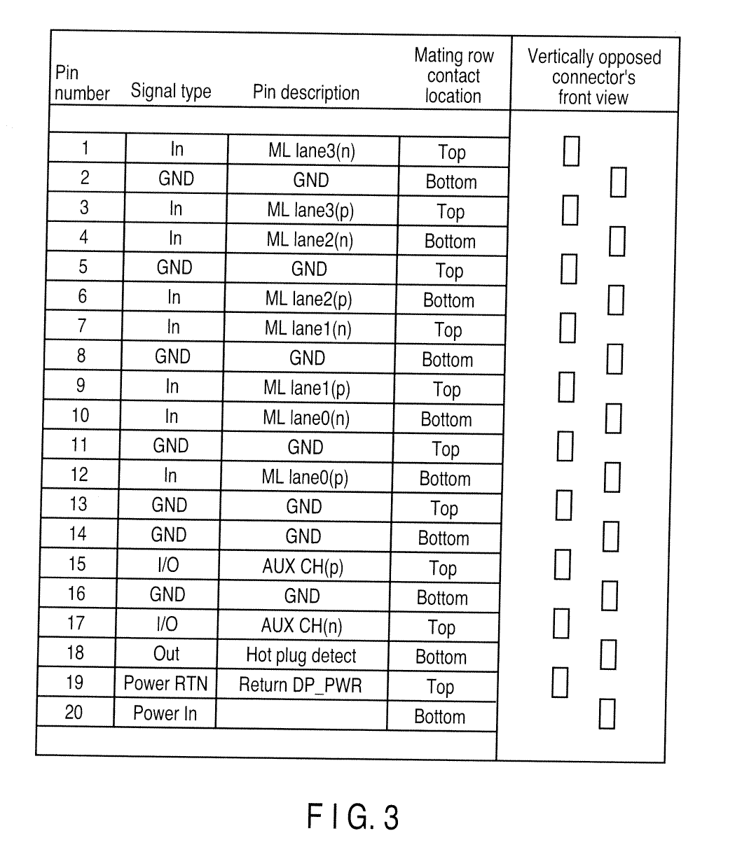

Further, FIG. 3 shows a pin arrangement of Displayport terminals. The Displayport terminals receive input signals each including digital video data and digital audio data. Thus, the Displayport terminals are substantially identical to the HDMI terminals 20-1, 20-2, 20-3, and can be added to provide selection candidates of input signals. Here, it is suitable to make pin-15 and pin-17 AUX_CH(p/n), and pin-20 DP_PWR the detection object.

(Generation Processing of Input Signal Selection Screen)

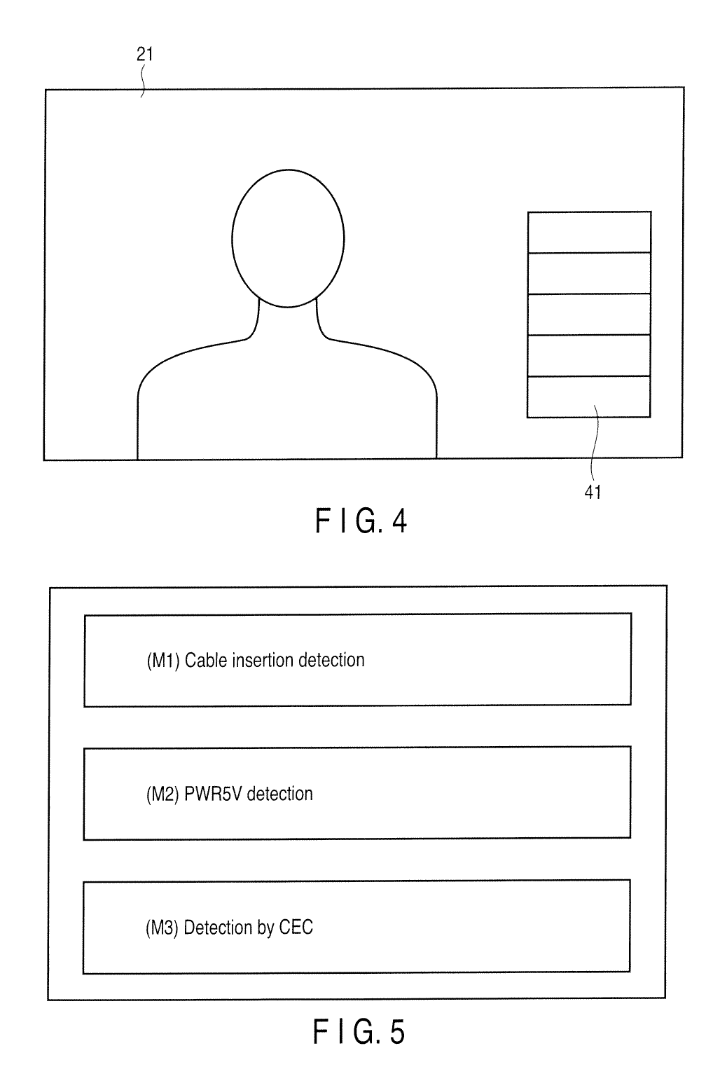

Next, an example of generation processing of an input signal selection screen in the display processing apparatus which is the embodiment of the present invention will be described below by using the drawings. FIG. 4 is an explanatory view showing an example the input signal selection screen of the display processing apparatus. In FIG. 4, the input signal selection screen is part of an image displayed on a display section 21 of an ordinary television set or the like, as an aggregate 41 of icons that allow selection to be made by a remote controller or the like.

Setting of Detection Method

To set an input signal detection method for each terminal, the HDMI signal detection section 34 is provided with a setting screen shown in FIG. 5, for example. An input signal detection method for each terminal is set as a default value or by a user operation on the setting screen.

Here, “(M1) cable insertion detection” in FIG. 5 implies detecting of the potential of pin-15 serial data clock line (SCL), and pin-16 serial data analyzer (SDA) for the case where an HDMI cable from electronic equipment such as an HDD recorder, an AV amplifier, or the like is connected to the HDMI terminal 20-1, 20-2, or 20-3. Further, “(M2) PWR5V detection” implies detecting of a pin-18 +5V power source for the case where the HDMI cable is connected to the HDMI terminal 20-1, 20-2, or 20-3, in the same manner as M1. Furthermore, “(M3) detection by CEC” implies detecting a communication status (whether or not the equipment is in communication with equipment of another party) of pin-13 CEC for the case where the HDMI cable is connected to the HDMI terminal 20-1, 20-2, or 20-3, in the same manner as M1 and M2.

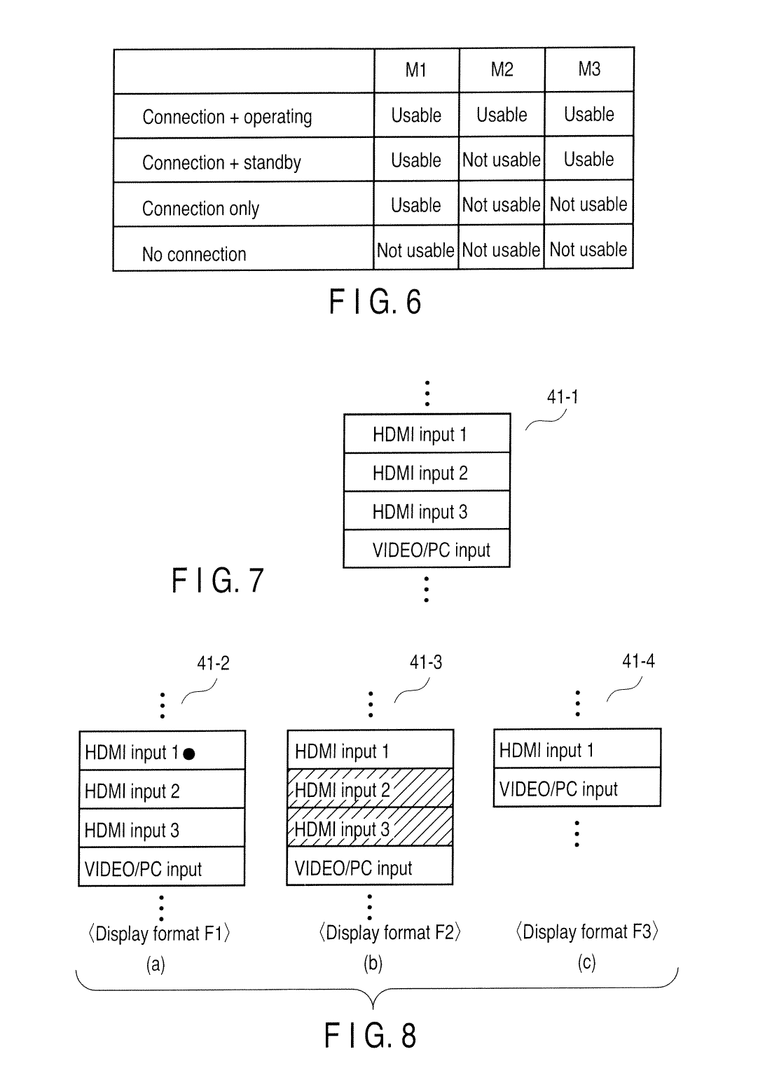

For example, as shown in FIG. 6, the statuses of the VIDEO/PC input terminal or HDMI terminal such as “connection+operating”, “connection+standby”, “connection only”, and “no connection” have relationships with the detection methods set on the setting screen of FIG. 5. In “(M1) cable insertion detection”, “connection+operating”, “connection+standby”, and “connection only” can be distinguished from “no connection”. Conversely, here, “connection+operating”, “connection+standby”, and “connection only” cannot be distinguished electrically from each other. Likewise, in “(M2) PWR5V detection”, “connection+operating” can be distinguished from “connection+standby”, “connection only”, and “no connection”. Likewise, in “(M3) detection by CEC”, “connection+operating” and “connection+standby” can be distinguished from “connection only” and “no connection”.

Incidentally, “connection” implies, for example, a status where the HDMI terminal and the equipment of the other party are connected via a cable, but it is not confirmed that this equipment is operating.

Further, “no connection” implies, for example, a status where the HDMI terminal and the equipment are not connected via a cable.

Further, “operating” implies, for example, that the equipment connected to the HDMI terminal via a cable is operating.

Further, “standby” implies, for example, that the equipment connected to the HDMI terminal via a cable is not operating but standing by.

(Input Signal Selection Screen)

As shown in FIG. 7, an input signal selection screen is displayed as an aggregate 41-1 of icons such as “video input”, “HDMI input 1”, “HDMI input 2”, “HDMI input 3”, and “PC input”, or the like.

The HDMI signal detection section 34 and the image generation section 30-1 operate to detect a connection status of each input terminal of HDMI or the like by the method set previously on the setting screen of FIG. 5, and determine, on the basis of the detection result, whether or not the input terminal is usable for selection.

A result of this is reflected to an input signal selection screen shown in FIG. 7, for example. That is, as shown in FIG. 8, selectable ones of the input signals of the input terminals are displayed or displayed in a form distinguishable from other input signals. Accordingly, it is easy for the user to grasp the input terminals which are useable for selection or the input terminals which are not usable for selection, and the operability of the input signal selection screen can be improved.

In (a) of FIG. 8, it is indicated by a mark that the HDMI input 1 is selectable, and the HDMI input 2 and HDMI input 3 are not selectable. Further, in (b) of FIG. 8, it is indicated by shadowing of the icons that the HDMI input 1 is selectable, and the HDMI input 2 and HDMI input 3 are not selectable.

Further, in (c) of FIG. 8, it is indicated by not displaying the HDMI input 2 and HDMI input 3 on the screen that the HDMI input 1 is selectable, and the HDMI input 2 and HDMI input 3 are not selectable.

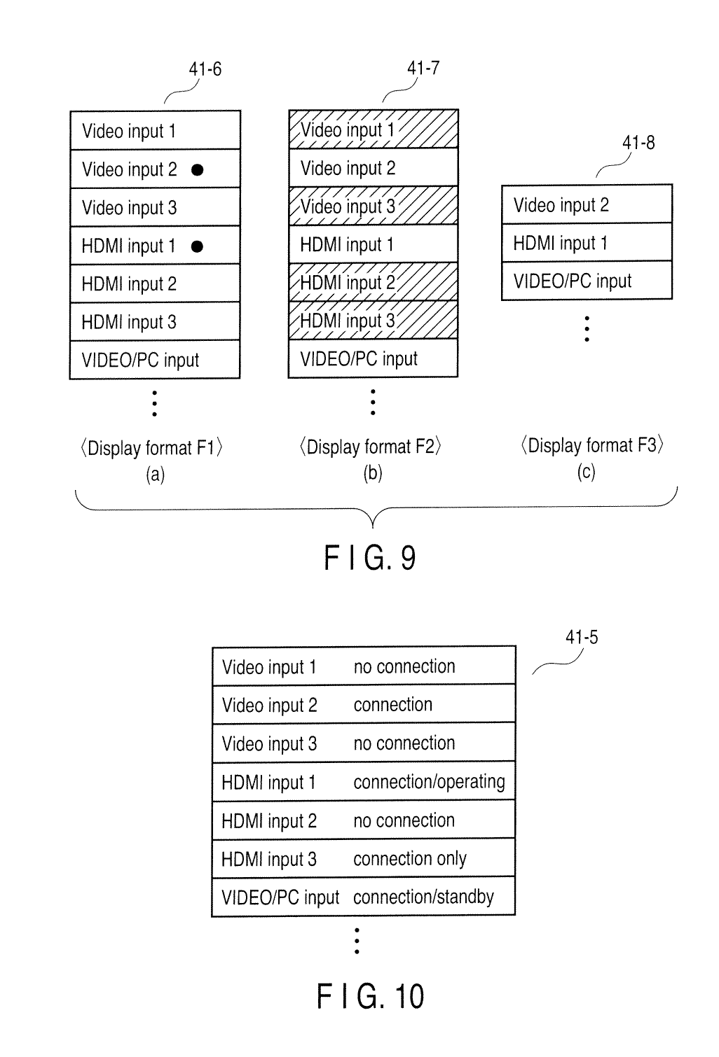

Further, as shown in FIG. 9, by including not only the HDMI terminals and the VIDEO/PC input terminal but also Displayport terminals for video inputs 1 to 3 in the detection object, the video inputs, HDMI inputs, and VIDEO/PC input can be made the display object of the input signal selection screen.

In (a) of FIG. 9, it is indicated by marks that the video input 2 and HDMI input 1 are selectable, and the other inputs are not selectable. Further, in (b) of FIG. 9, it is indicated by shadowing of the icons that the video input 2 and HDMI input 1 are selectable, and the other inputs are not selectable.

Further, in (c) of FIG. 9, it is indicated that the video input 2 and HDMI input 1 are selectable, and the other inputs are not selectable, by not displaying the other icons on the screen.

In the case where the Displayport terminals described above are provided, the control section 30 or the like operates to detect the pin potentials of the Displayport terminals and determine the connection status, whereby the Displayport terminals can also be made the display object.

Moreover, in the case where all the detection methods of (M1) cable insertion detection, (M2) PWR5V detection, and (M3) detection of communication status of CEC terminal are set together, it is possible to electrically distinguish the statuses of “connection+operating”, “connection+standby”, “connection only”, and “no connection” from each other.

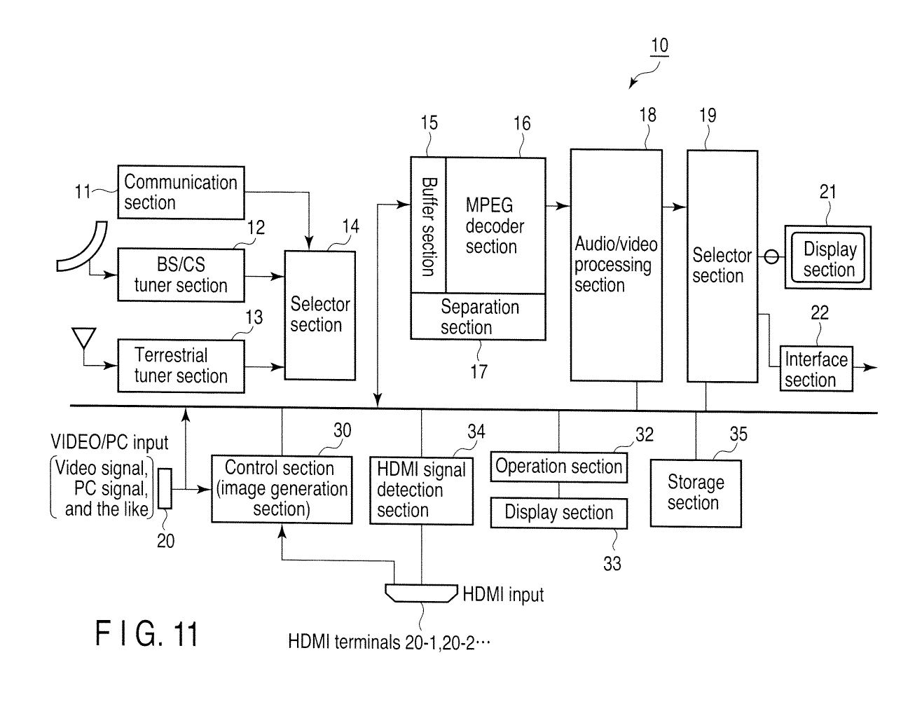

Accordingly, it becomes possible to perform display of “no connection”, “connection”, “connection/operating”, “connection/standby”, and the like for each input signal as shown in FIG. 10.

In the embodiment, the HDMI terminals 20-1, 20-2 and 20-3 are provided as input terminals which receive input signals each including digital video data and digital audio data. The HDMI signal detection section 34 detects the signal pin potentials of the input terminals. The control section 30 determines specific ones of the input terminals on the basis of a detection result from the HDMI signal detection section 34 and generates an input signal selection screen on which input signals of the specific input terminals are displayed as selection candidates distinguishable from other input signals. The signal processing section 18′ processes an input signal which is one of the selection candidates selected on the input signal selection screen.

In addition, the control section 30 may confirm that a detected potential exceeds a threshold, in determination of the specific input terminals.

The input signals of the specific input terminals may be distinguished from the other input signals not only by a mark provided to the icons, but also by a color provided to the selection candidates.

The HDMI signal detection section 34 may perform detection with respect to at least one of the SCL and SDA pins in the HDMI terminal. The HDMI signal detection section 34 may perform detection with respect to the +5V power source pin in the HDMI terminal. The HDMI signal detection section 34 may perform detection with respect to the CEC pin in the HDMI terminal. The HDMI signal detection section 34 may determines a detection method for one of the SCL and SDA pins, the +5V power source pin, and the CEC pin in the input terminal in accordance with an operation signal obtained on a setting screen.

<An Example of a Display Processing Apparatus which is Another Embodiment of the Present Invention>

A receiving device serving as the display processing apparatus and a reproducing device of a recording medium connected to the receiving device by an HDMI cable will be described below in detail by using the drawings. FIG. 11 is an exemplary block diagram showing the configuration of the receiving device.

(Configuration and Operation of Receiving Device)

The receiving device 10 of FIG. 11 is a television receiver adapted to HDMI-CEC, in which a control section 30 is connected to other components via a data bus in order to control the entire operation.

Further, in the receiving device of FIG. 11, the control section 30 and a MPEG decoder section 16 are provided as main components. The MPEG decoder section 16 is a reproduction module, and the control section 30 is a control module for the main body operation. The receiving device 10 includes a selector section 14 on the input side, and a selector section 19 on the output side. The input side selector section 14 is connected to a communication section 11 having network (e.g., LAN) communication and mail functions, a BS/CS tuner section 12 of a satellite broadcast, and a terrestrial tuner section 13. Further, the BS/CS tuner section 12 is connected to a reception antenna for satellite broadcast signals, and the terrestrial tuner section 13 is connected to a reception antenna for terrestrial broadcast signals.

Further, the receiving device 10 includes a separation section 17 for the MPEG decoder section 16, an HDMI signal detection section 34, and a storage section 35. These sections are connected to the control section 30 via the data bus. Further, the selector section 19 is connected to supply an output to a display section 21 and to an interface section 22 which performs communication with the external apparatus. The output is supplied via the interface section 22 to the external apparatus.

Further, the receiving device 10 includes an operation section 32 which is connected to the control section 30 via the data bus, and accepts operations made by a user and a remote controller R. Here, the remote controller R may be operated in the substantially same manner as the operation section 32 to perform various settings, for example, of a tuner operation. In the receiving device 10, HDMI terminals 20-1, 20-2, 20-3 and the like are connected to the control section 30 and the data bus.

In this receiving device 10, the broadcast signals are input from the reception antennas to the tuner sections 12 and 13 in which channel selection is performed to obtain a video/audio signal from the broadcast signals. The video/audio signal is subjected to decode processing, for example, in the MPEG decoder section 16, and is then supplied to an audio/video processing section 18. The MPEG decoder section 16 and the audio/video processing section 18 are also used to process the signals input from the HDMI terminals 20-1 to 20-3 and the like which are connected to external equipment such as a VTR, DVD and the like.

These input signals are managed by the control section 30 and selected as a signal to be input to the audio/video processing section 18.

Further, when channel selection or input selection is carried out, an operation signal from the remote controller R is supplied to the control section 30 via the operation section 32 so as to control the MPEG decoder section 16 and the audio/video processing section 18. A video signal obtained as a processing result of the audio/video processing section 18 is displayed on the display section 21 which receives the signal via the selector section 19. Further, an audio signal obtained as a processing result of the audio/video processing section 18 is supplied to a speaker or the like (not shown).

Here, as described above, the connection statuses of the input terminals of HDMI or the like are detected by the HDMI signal detection section 34, the control section 30 or the like, and selectable ones of input signals of the input terminals are displayed or indicated as selection candidates distinguishable from other input signals on the input signal selection screen, whereby the operability of the input signal selection screen is improved.

(1) According to one embodiment of the invention, a display apparatus comprising:

input terminals which receive input signals each including digital video data and digital audio data;

a detection module which detects the signal pin potentials of the input terminals;

a generation module which determines specific ones of the input terminals on the basis of a detection result from the detection module and generates an input signal selection screen on which input signals of the specific input terminals are displayed as selection candidates distinguishable from other input signals; and

a processing module which processes an input signal which is one of the selection candidates selected on the input signal selection screen.

(2) According to one embodiment of the invention, the display apparatus of (1), wherein the generation module is configured to confirm that a detected potential exceeds a threshold, in determination of the specific input terminals.

(3) According to one embodiment of the invention, the display apparatus of (1), wherein the input signals of the specific input terminals are distinguished from the other input signals by a mark or color provided to the selection candidates.

(4) According to one embodiment of the invention, the display apparatus of (1), wherein the input terminals are of the HDMI standard, and the detection module is configured to perform detection with respect to at least one of the SCL and SDA pins in the input terminal of the HDMI standard.

(5) According to one embodiment of the invention, the display apparatus of (1), wherein the input terminals are of the HDMI standard, and the detection module is configured to perform detection with respect to the +5V power source pin in the input terminal of the HDMI standard.

(6) According to one embodiment of the invention, the display apparatus of (1), wherein the input terminals are of the HDMI standard, and the detection module detects is configured to perform detection with respect to the CEC pin in the input terminal of the HDMI standard.

(7) According to one embodiment of the invention, the display apparatus of (1), wherein the input terminals are of the HDMI standard, and the detection module determines a detection method for one of the SCL and SDA pins, the +5V power source pin, and the CEC pin in the input terminal in accordance with an operation signal obtained on a setting screen.

(8) According to one embodiment of the invention, the display apparatus of (1), wherein:

the input terminals are of the HDMI standard;

Displayport terminals are added as input terminals; and

the detection module, the generation module and the processing module are configured to operate on the Displayport terminals in the same manner as the input terminals of the HDMI standard.

(9) According to one embodiment of the invention, a display processing method comprising:

detecting the signal pin potentials of input terminals which receive input signals each including digital video data and digital audio data;

determining specific ones of the input terminals on the basis of a detection result; and

displaying an input signal selection screen on which input signals of the specific input terminals are indicated as selection candidates distinguishable from other input signals.

The various modules of the systems described herein can be implemented as software applications, hardware and/or software modules, or components on one or more computers, such as servers. While the various modules are illustrated separately, they may share some modules are illustrated separately, they may share some or all of the same underlying logic or code.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

The display processing apparatus and the display processing method can be utilized to emphasize selectable input signals on an input signal selection screen.

What is claimed is:

1. A display processing apparatus comprising:
a first input terminal of the HDMI standard, configured to be connectable to an external apparatus;
a detector configured to detect (i) a first signal which is included in an input signal supplied from the first input terminal, and (ii) a second signal which is included in the input signal supplied from the first input terminal and which is different from the first signal; and
a generator configured to determine whether the external apparatus is not in a standby state but in an operating state based on a detecting result of the detector, and to generate an input signal selection screen representing the operating state of the external apparatus when the external apparatus is determined to be in the operating state.

2. The apparatus of claim 1, further comprising:
a second input terminal different from the first input terminal,
wherein the detector is configured to detect a signal supplied from the second input terminal, and
the generator is configured to generate the input signal selection screen representing a connection or no connection state between the second input terminal and the external apparatus, based on the detecting result of the detector.

3. The apparatus of claim 1, further comprising:
a second input terminal different from the first input terminal,
wherein the detector is configured to detect a signal supplied from the second input terminal, and
the generator is configured to generate the input signal selection screen based on the detecting result of the detector, the input signal selecting screen including information on the first input terminal when the first input terminal is selectable, and including information on the second input terminal when the second input terminal is selectable.

4. The apparatus of claim 1, wherein the detector is configured to detect the first signal representing a power source potential, and the second signal representing whether or not a communication status is established with the external apparatus.

5. The apparatus of claim 1, wherein the detector is configured to detect a third signal included in the input signal supplied from the first input terminal, and
the generator is configured to generate the input signal selection screen including information representing a connected state of the external apparatus, when the external apparatus is determined to be in the connected state based on the detecting result of the detector.

6. The apparatus of claim 5, wherein the detector is configured to detect the third signal representing cable insertion detecting.

7. A display processing apparatus comprising:
an input terminal of the HDMI standard, to which an external apparatus is connected;
a detector configured to detect (i) a first signal which is included in an input signal supplied from the input terminal, and (ii) a second signal which is included in the input signal supplied from the input terminal and which is different from the first signal; and
a generator configured to determine whether the external apparatus is in an operating state or in a standby state, and to generate an input signal selection screen representing the operating state of the external apparatus when the external apparatus is determined to be in the operating state.

8. A display processing apparatus comprising:
an input terminal of the HDMI standard, to which an external apparatus is connected;
a detector configured to detect (i) a first signal which is included in an input signal supplied from the first input terminal, and (ii) a second signal which is included in the input signal supplied from the first input terminal and which is different from the first signal; and
a generator configured to determine a first state in which the external apparatus is in an operating state, a second state in which the external apparatus is in a standby state, or a third state in which the external apparatus is merely in a connected state, one of the first to third states being determined based on a detecting result of the detector, the external apparatus being selectable when the first state is determined, and the generator being configured to generate an input signal selection screen representing the first state.
